(19) United States
(12) Patent Application Publication
(10) Pub. No.: US 2016/0152801 A1
(43) Pub. Date: Jun. 2, 2016

(54) Polymer Composition with Improved Flammability Performance

(71) Applicant: Ticona LLC, Florence, KY (US)

(72) Inventors: Yuehua Yu, Cincinnati, OH (US); Mark Allen Tyler, Richmond, OH (US)

(21) Appl. No.: 14/951,826

(22) Filed: Nov. 25, 2015

Related U.S. Application Data
(60) Provisional application No. 62/085,791, filed on Dec. 1, 2014.

(51) Int. Cl. C08K 7/14; C08J 5/00; C08K 5/5393; C08K 3/34

(52) U.S. Cl. CPC C08K 7/14; C08K 3/34; C08J 5/00; C08K 5/5393; C08J 2300/00

(57) ABSTRACT

A polymer composition for use in a molded part is provided. The composition comprises a highly flowable, liquid crystalline polymer blended with a relatively small amount of an inorganic filler (e.g., glass fibers, mineral filler, etc.). Although the composition contains only a small amount of the filler, the resulting molded part can still exhibited improved flammability performance. More particularly, the present inventors have surprisingly discovered that the use of an organophosphorous compound within a certain concentration can improve the flammability properties of the composition without sacrificing other properties of the part, such as blister resistance.

### RELATED APPLICATIONS

The present application claims priority to U.S. Provisional Application Ser. No. 62/085,791, filed on Dec. 1, 2014, which is incorporated herein in its entirety by reference thereto.

### BACKGROUND OF THE INVENTION

Electrical components often contain molded parts that are formed from a liquid crystalline, thermoplastic resin. Recent demands on the electronic industry have dictated a decreased size of such components to achieve the desired performance and space savings. One such component is an electrical connector, which can be external (e.g., used for power or communication) or internal (e.g., used in computer disk drives or servers, link printed wiring boards, wires, cables and other EEE components). Due to the manner in which they are employed, most electrical components are required to meet certain flammability standards that minimize the risk of the dripping and stringing of the part onto a heat source, e.g., an electric heating element or open flame. One solution for this problem has been to produce products with a relatively high level of an anti-dripping additive, such as glass fibers or polytetrafluoroethylene (PTFE). While such additives can improve the flammability properties of the composition, they often lead to other problems, such as poor mechanical and thermal properties (e.g., flowability or heat resistance) and sacrificed flowability. As such, a need currently exists for a polymer composition that can possess good flammability properties, yet also maintain good mechanical and thermal properties and flowability.

### SUMMARY OF THE INVENTION

In accordance with another embodiment of the present invention, polymer composition is disclosed that comprises a liquid crystalline polymer having a melt viscosity of about 50 Pa-s or less as determined in accordance with ISO Test No. 11443 at a shear rate of 1000 s⁻¹ and a temperature that is 15° C. higher than the melting temperature of the polymer (e.g., 350° C.). The polymer is melt blended with an inorganic filler in an amount of from about 0.1 to about 35 parts per 100 parts of the polymer and an organophosphorous compound in an amount of from about 0.01 to about 5 parts per 100 parts of the polymer.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is an exploded perspective view of one embodiment of a fine pitch electrical connector that may be formed according to the present invention;

FIG. 2 is a front view of opposing walls of the fine pitch electrical connector of FIG. 1;

FIG. 3 is a schematic illustration of one embodiment of an extruder screw that may be used to form the polymer composition of the present invention;

FIGS. 4-5 are respective front and rear perspective views of an electronic component that can employ an antenna structure formed in accordance with one embodiment of the present invention; and

FIGS. 6-7 are perspective and front views of a compact camera module (“CCM”) that may be formed in accordance with one embodiment of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition for use in molded parts. The polymer composition comprises a thermotropic liquid crystalline polymer blended with a relatively small amount of an inorganic filler (e.g., glass fibers, mineral filler, etc.), such as from about 0.1 to about 35 parts, in some embodiments from about 0.5 to about 30 parts, and in some embodiments, from about 1 to about 20 parts per 100 parts of the liquid crystalline polymer. Although the composition contains only a small amount of the inorganic filler, the resulting molded part can still exhibited excellent flammability performance. More particularly, the present inventors have surprisingly discovered that the use of an organophosphorous compound within a certain concentration can improve the flammability properties of the part without sacrificing other properties of the part, such as blister resistance. Organophosphorous compounds, for instance, typically constitute from about 0.01 to about 5 parts, in some embodiments from about 0.02 to about 1 part, and in some embodiments, from about 0.05 to about 0.5 parts per 100 parts of the liquid crystalline polymer.

The flammability of the part may, for instance, be determined in accordance the procedure of Underwriter's Laboratory Bulletin 94 entitled “Tests for Flammability of Plastic Materials, UL94.” Several ratings can be applied based on the time to extinguish (total flame time) and ability to resist dripping as described in more detail below. According to this procedure, for example, the molded part may achieve a V0 rating, which means that the part has a total flame time of about 50 seconds or less, determined at a given part thickness (e.g., 0.25 mm or 0.8 mm). To achieve a V0 rating, the part may also have a total number of drips of burning particles that ignite cotton of 0. For example, when exposed to an open flame, the molded part may exhibit a total flame time of about 50 seconds or less, in some embodiments about 45 seconds or less, and in some embodiments, from about 1 to about 40 seconds. Furthermore, the total number of drips of burning particles produced during the UL94 test may be 3 or less, in some embodiments 2 or less, and in some embodiments, 1 or less (e.g., 0). Such testing may be performed after conditioning for 48 hours at 23° C. and 50% relative humidity.

Notably, the improved flammability properties are possible even though the polymer employed in the composition is highly flowable. That is, the polymer generally has a melt viscosity of about 50 Pa-s or less, in some embodiments from about 0.1 to about 40 Pa-s, and in some embodiments, from about 0.5 to about 30 Pa-s. Likewise, the resulting polymer composition may have a melt viscosity of about 80 Pa-s or less, in some embodiments from about 0.1 to about 60 Pa-s, and in some embodiments, from about 0.5 to about 50 Pa-s. Melt viscosity may be determined in accordance with ISO Test No. 11443 at a shear rate of 1000 s⁻¹ and a temperature that is 15° C. higher than the melting temperature of the polymer (e.g., 350° C.). As indicated, the molded part may also possess good thermal properties. For instance, the part may exhibit a relatively high degree of heat resistance, which is characterized by a “blister free temperature” of about 240° C. or greater, in some embodiments about 250° C. or greater, in some embodiments from about 260° C. to about 320° C., and in some embodiments, from about 270° C. to about 300° C. As explained in more detail below, the “blister free temperature” is the maximum temperature at which a molded part does not exhibit blistering when placed in a heated silicone oil bath or exposed to IR reflow tunnel. Such blisters generally form when the vapor pressure of trapped moisture exceeds the strength of the part, thereby leading to delamination and or surface defects.

Conventionally, it was believed that parts having the properties noted above would not also possess sufficiently good mechanical properties to enable their use in certain types of applications. Contrary to conventional thought, however, the molded part of the present invention has been found to also possess excellent mechanical properties. For example, the part may exhibit a high impact strength, which is useful when forming small parts. The part may, for instance, possess a Charpy notched impact strength greater than about 4 kJ/m², in some embodiments from about 5 to about 40 kJ/m², and in some embodiments, from about 6 to about 30 kJ/m², measured at 23° C. according to ISO Test No. 179-1) (technically equivalent to ASTM D256, Method B). The tensile and flexural mechanical properties of the composition are also good. For example, the part may exhibit a tensile strength of from about 20 to about 500 MPa, in some embodiments from about 50 to about 400 MPa, and in some embodiments, from about 100 to about 350 MPa; a tensile break strain of about 0.5% or more, in some embodiments from about 0.6% to about 20%, and in some embodiments, from about 0.8% to about 3.5%; and/or a tensile modulus of from about 5,000 MPa to about 30,000 MPa, in some embodiments from about 8,000 MPa to about 20,000 MPa, and in some embodiments, from about 10,000 MPa to about 15,000 MPa. The tensile properties may be determined in accordance with ISO Test No. 527 (technically equivalent to ASTM D638) at 23° C. The part may also exhibit a flexural strength of from about 20 to about 500 MPa, in some embodiments from about 50 to about 400 MPa, and in some embodiments, from about 100 to about 350 MPa; a flexural break strain of about 0.5% or more, in some embodiments from about 0.6% to about 20%, and in some embodiments, from about 0.8% to about 3.5%; and/or a flexural modulus of from about 5,000 MPa to about 30,000 MPa, in some embodiments from about 8,000 MPa to about 20,000 MPa, and in some embodiments, from about 10,000 MPa to about 15,000 MPa. The flexural properties may be determined in accordance with ISO Test No. 178 (technically equivalent to ASTM D790) at 23° C.

Various embodiments of the present invention will now be described in more detail.

### I. Liquid Crystalline Polymer

The thermotropic liquid crystalline polymer generally has a high degree of crystallinity that enables it to effectively fill the small spaces of a mold. Suitable thermotropic liquid crystalline polymers may include aromatic polyesters, aromatic poly(esteramides), aromatic poly(estercarbonates), aromatic polyamides, etc., and may likewise contain repeating units formed from one or more aromatic hydroxycarboxylic acids, aromatic dicarboxylic acids, aromatic diols, aromatic aminocarboxylic acids, aromatic amines, aromatic diamines, etc., as well as combinations thereof. In one particular embodiment, the liquid crystalline polymer is an aromatic polyester that contains aromatic ester repeating units generally represented by the following Formula (II):

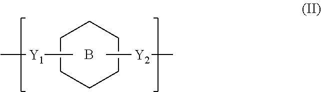

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O), wherein at least one of Y₁ and Y₂ are C(O).

Examples of aromatic ester repeating units that are suitable for use in the present invention may include, for instance, aromatic dicarboxylic repeating units (Y₁ and Y₂ in Formula II are C(O)), aromatic hydroxycarboxylic repeating units (Y₁ is O and Y₂ is C(O) in Formula II), as well as various combinations thereof.

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, 2,6-naphthalenedicarboxylic acid (“NDA”), terephthalic acid (“TA”), and isophthalic acid (“IA”). When employed, for instance, NDA may constitute from about 5 mol. % to about 40 mol. %, in some embodiments from about 10 mol. % to about 35 mol. %, and in some embodiments, from 15 mol. % to about 30 mol. % of the polymer, while TA and/or IA may constitute from about 0.1 mol. % to about 20 mol. %, in some embodiments from about 0.5 mol. % to about 15 mol. %, and in some embodiments, from about 1 mol. % to about 10% of the polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 6-hydroxy-2-naphthoic acid (“HNA”) and 4-hydroxybenzoic acid (“HBA”). When employed, for instance, HBA may constitute from about 5 mol. % to about 70 mol. %, in some embodiments from about 10 mol. % to about 60 mol. %, and in some embodiments, from about 20 mol. % to about 50 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 60 mol. %, in some embodiments from about 5 mol. % to about 40 mol. %, and in some embodiments, from about 10 mol. % to about 30% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids (e.g., cyclohexane dicarboxylic acid), diols, amides, amines, etc. Of course, in other embodiments, the polymer may be “wholly aromatic” in that it lacks repeating units derived from non-aromatic (e.g., aliphatic or cycloaliphatic) monomers.

Although not necessarily required, it may be desired that the liquid crystalline polymer is “naphthenic-rich” to the extent that it contains a high content of repeating units derived from naphthenic hydroxycarboxylic acids and naphthenic dicarboxylic acids, such as 2,6-naphthalenedicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) is typically more than about 5 mol. %, in some embodiments more than about 10 mol. %, in some embodiments more than about 15 mol. %, and in some embodiments, from 15 mol. % to about 35 mol. % of the polymer. Without intending to be limited by theory, it is believed that such a high content of naphthenic repeating units can disrupt the linear nature of the polymer backbone, thereby helping to enhance the flowability and flame retardance of the composition. In one particular embodiment, for example, a “naphthenic-rich” aromatic polyester may be formed that contains monomer repeat units derived from a naphthenic acid (e.g., NDA and/or HNA); 4-hydroxybenzoic acid (“HBA”), terephthalic acid (“TA”) and/or isophthalic acid (“IA”); as well as various other optional constituents. The monomer units derived from 4-hydroxybenzoic acid (“HBA”) may constitute from about 5 mol. % to about 70 mol. %, in some embodiments from about 10 mol. % to about 60 mol. %, and in some embodiments, from about 20 mol. % to about 50 mol. % of the polymer, while the monomer units derived from terephthalic acid (“TA”) and/or isophthalic acid (“IA”) may each constitute from about 0.1 mol. % to about 20 mol. %, in some embodiments from about 0.5 mol. % to about 15 mol. %, and in some embodiments, from about 1 mol. % to about 10% of the polymer. Other possible monomer repeat units include aromatic diols, such as 4,4′-biphenol (“BP”), hydroquinone (“HQ”), etc. and aromatic amides, such as acetaminophen (“APAP”). In certain embodiments, for example, BP and/or HQ may each constitute from about constitute 1 mol. % to about 60 mol. %, in some embodiments from about 5 mol. % to about 40 mol. %, and in some embodiments, from about 10 mol. % to about 30% of the polymer when employed.

The liquid crystalline polymer may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 210° C. to about 400° C., and in some embodiments, from about 250° C. to about 350° C. For instance, one suitable technique for forming the liquid crystalline polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to a temperature of from about 210° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. The resin may also be in the form of a strand, granule, or powder. While unnecessary, it should also be understood that a subsequent solid phase polymerization may be conducted to further increase molecular weight. When carrying out solid-phase polymerization on a polymer obtained by melt polymerization, it is typically desired to select a method in which the polymer obtained by melt polymerization is solidified and then pulverized to form a powdery or flake-like polymer, followed by performing solid polymerization method, such as a heat treatment in a temperature range of 200° C. to 350° C. under an inert atmosphere (e.g., nitrogen).

Regardless of the particular method employed, the resulting liquid crystalline polymer may have a relatively high melting temperature. For example, the melting temperature of the polymer may be from about 250° C. to about 450° C., in some embodiments from about 280° C. to about 420° C., in some embodiments from about 290° C. to about 400° C., and in some embodiments, from about 300° C. to about 400° C. Of course, in some cases, the polymer may not exhibit a distinct melting temperature when determined according to conventional techniques (e.g., DSC). The polymer typically has a number average molecular weight (Mₙ) of about 2,000 grams per mole or more, in some embodiments from about 4,000 grams per mole or more, and in some embodiments, from about 5,000 to about 50,000 grams per mole. Of course, it is also possible to form polymers having a lower molecular weight, such as less than about 2,000 grams per mole, using the method of the present invention. The intrinsic viscosity of the polymer, which is generally proportional to molecular weight, may also be relatively high. For example, the intrinsic viscosity may be about 1 deciliter per gram (“dL/g”) or more, in some embodiments about 2 dL/g or more, in some embodiments from about 3 to about 20 dL/g, and in some embodiments from about 4 to about 15 dL/g. Intrinsic viscosity may be determined in accordance with ISO-1628-5 using a 50/50 (v/v) mixture of pentafluorophenol and hexafluoroisopropanol, as described in more detail below.

### II. Organophosphorous Compound

As indicated above, the polymer composition of the present invention also contains an organophosphorous compound. Without intending to be limited by theory, the present inventors have surprisingly discovered that such a compound can improve the flammability properties of the molded part without sacrificing other properties, such as blister resistance. Trivalent organophosphorous compounds (e.g., phosphites or phosphonites) are particularly useful in the present invention. Particularly suitable are aryl phosphonites (mono- or di-) that contain C₁ to C₁₀ alkyl substituents. These substituents may be linear (as in the case of nonyl substituents) or branched (such as isopropyl or tertiary butyl substituents). In one embodiment, for example, the aryl phosphonite has the following general formula (I):

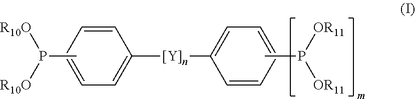

wherein,

m is 0 or 1;

n is 0 or 1;

R₁₀ and R₁₁ are independently an aliphatic, alicyclic or aromatic group of 1 to 24 carbon atoms, optionally further substituted (e.g., by linear or branched aliphatic groups or alkaryl substituents), or both groups R₁₀ and/or R₁₁ form a cyclic group with a single phosphorus atom;

Y is —O—, —S—, —CH(R₁₅)— or —C₆H₄—, where R₁₅ is hydrogen, C₁₋₆ alkyl, or COOR₆ and R₆ is C₁₋₁₈ alkyl.

If desired, m may be 1 so that the compound is a diphosphonite compound. For example, the diphosphonite compound may have the following general formula (x):

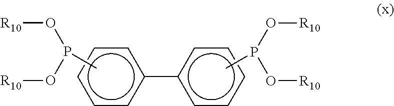

wherein R₁₀ and R₁₁ are as defined above. For instance, R₁₀ and R₁₁ may independently be linear, branched or cyclic C₁₋₂₄ aliphatic groups or aromatic groups (e.g., phenyl), optionally substituted with from 1 to 4 C₁₋₁₂ alkyl or aryl groups. For example, R₁₀ and/or R₁₁ may be 2,4-di-tert-butylphenyl. In one particular embodiment, the diphosphonite compound may be tetrakis(2,4-di-tert-butylphenyl)biphenylene diphosphonite, which is commercially available from Clariant GmbH and under the name Hostanox® P-EPQ and has the following general structure:

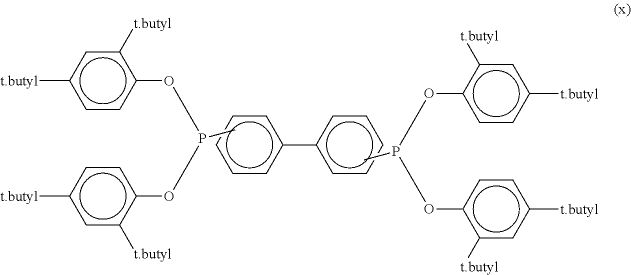

The organophosphorous compound may be formed entirely of a diphosphonite compound, such as described above. Alternatively, a mixture of diphosphonite compounds with monophosphonites and/or phosphites may be employed. In such embodiments, diphosphonite compounds typically constitute from about 50 wt. % to about 99 wt. %, in some embodiments from about 70 wt. % to about 95 wt. %, and in some embodiments, from about 75 wt. % to 90 wt. % of the additive. Monophosphonites and/or phosphites may likewise constitute from about 1 wt. % to about 50 wt. %, in some embodiments from about 5 wt. % to about 30 wt. %, and in some embodiments, from about 10 wt. % to about 25 wt. % of the organophosphorous compound.

### III. Inorganic Filler

An inorganic filler is also employed in the polymer composition to improve the mechanical properties. The relative amount of the inorganic filler in the polymer composition may be selectively controlled to help achieve the desired properties. For example, the filler typically constitutes from about 0.5 wt. % to about 30 wt. %, in some embodiments from about 1 wt. % to about 20 wt. %, and in some embodiments, from about 3 wt. % to about 12 wt. % of the polymer composition. Likewise, organophosphorous compounds typically constitute from about 0.01 wt. % to about 4 wt. %, in some embodiments from about 0.02 wt. % to about 1 wt. %, and in some embodiments, from about 0.05 wt. % to about 0.5 wt. % of the polymer composition. Liquid crystalline polymers may likewise constitute from about 60 wt. % to about 99 wt. %, in some embodiments from about 70 wt. % to about 98 wt. %, and in some embodiments, from about 80 wt. % to about 95 wt. % of the polymer composition.

Any of a variety of inorganic fillers may generally be employed in the composition. In one embodiment, for example, inorganic fibers may be employed. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. To help maintain an insulative property, which is often desirable for use in electronic components, the high strength fibers may be formed from materials that are also generally insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof.

The volume average length of the fibers may be from about 1 to about 400 micrometers, in some embodiments from about 80 to about 250 micrometers, in some embodiments from about 100 to about 200 micrometers, and in some embodiments, from about 110 to about 180 micrometers. The fibers may also have a narrow length distribution. That is, at least about 70% by volume of the fibers, in some embodiments at least about 80% by volume of the fibers, and in some embodiments, at least about 90% by volume of the fibers have a length within the range of from about 1 to about 400 micrometers, in some embodiments from about 80 to about 250 micrometers, in some embodiments from about 100 to about 200 micrometers, and in some embodiments, from about 110 to about 180 micrometers. Such a weight average length and narrow length distribution can further help achieve a desirable combination of strength and flowability, which enables it to be uniquely suited for molded parts with a small dimensional tolerance.

In addition to possessing the length characteristics noted above, the fibers may also have a relatively high aspect ratio (average length divided by nominal diameter) to help improve the mechanical properties of the resulting polymer composition. For example, the fibers may have an aspect ratio of from about 2 to about 50, in some embodiments from about 4 to about 40, and in some embodiments, from about 5 to about 20 are particularly beneficial. The fibers may, for example, have a nominal diameter of about 10 to about 35 micrometers, and in some embodiments, from about 15 to about 30 micrometers.

In yet another embodiment, mineral fillers may be employed, either alone or in combination with inorganic fibers. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂,(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂.4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof.

### IV. Optional Components

Still other additives that can be included in the composition may include, for instance, mineral fillers, antimicrobials, lubricants, pigments, antioxidants, stabilizers, surfactants, waxes, solid solvents, flow aids, and other materials added to enhance properties and processability. While various optional components may be employed, it is typically desired that the composition is generally free of conventional anti-dripping agents, such as polytetrafluoroethylene (“PTFE”). For example, the composition typically contains no more than about 1 wt. %, in some embodiments no more than about 0.5 wt. %, and in some embodiments, no more than about 0.1 wt. % (e.g., 0 wt. %) of PTFE.

### V. Formation of Composition

The liquid crystalline polymer, organophosphorous compound, filler, and other optional additives may be melt blended together within a temperature range of from about 200° C. to about 450° C., in some embodiments, from about 220° C. to about 400° C., and in some embodiments, from about 250° C. to about 350° C. to form the polymer composition. Any of a variety of melt blending techniques may generally be employed in the present invention. For example, the components (e.g., liquid crystalline polymer, organophosphorous compound, filler, etc.) may be supplied separately or in combination to an extruder that includes at least one screw rotatably mounted and received within a barrel (e.g., cylindrical barrel) and may define a feed section and a melting section located downstream from the feed section along the length of the screw.

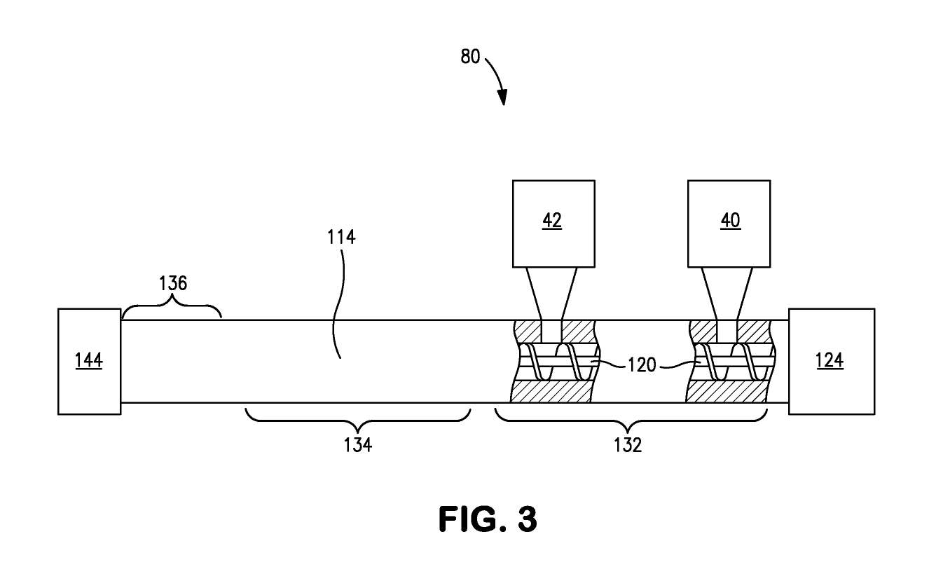

The extruder may be a single screw or twin screw extruder. Referring to FIG. 3, for example, one embodiment of a single screw extruder 80 is shown that contains a housing or barrel 114 and a screw 120 rotatably driven on one end by a suitable drive 124 (typically including a motor and gearbox). If desired, a twin-screw extruder may be employed that contains two separate screws. The configuration of the screw is not particularly critical to the present invention and it may contain any number and/or orientation of threads and channels as is known in the art. As shown in FIG. 3, for example, the screw 120 contains a thread that forms a generally helical channel radially extending around a core of the screw 120. A hopper 40 is located adjacent to the drive 124 for supplying the liquid crystalline polymer and/or other materials (e.g., aromatic carboxylic acids) through an opening in the barrel 114 to the feed section 132. Opposite the drive 124 is the output end 144 of the extruder 80, where extruded plastic is output for further processing.

A feed section 132 and melt section 134 are defined along the length of the screw 120. The feed section 132 is the input portion of the barrel 114 where the liquid crystalline polymer and/or organophosphorous compound are added. The melt section 134 is the phase change section in which the liquid crystalline polymer is changed from a solid to a liquid. While there is no precisely defined delineation of these sections when the extruder is manufactured, it is well within the ordinary skill of those in this art to reliably identify the feed section 132 and the melt section 134 in which phase change from solid to liquid is occurring. Although not necessarily required, the extruder 80 may also have a mixing section 136 that is located adjacent to the output end of the barrel 114 and downstream from the melting section 134. If desired, one or more distributive and/or dispersive mixing elements may be employed within the mixing and/or melting sections of the extruder. Suitable distributive mixers for single screw extruders may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further improved by using pins in the barrel that create a folding and reorientation of the polymer melt, such as those used in Buss Kneader extruders, Cavity Transfer mixers, and Vortex Intermeshing Pin mixers.

The filler can also be added to the hopper 40 or at a location downstream therefrom. In one particular embodiment, the filler may be added a location downstream from the point at which the liquid crystalline polymer is supplied, but yet prior to the melting section. In FIG. 3, for instance, a hopper 42 is shown that is located within a zone of the feed section 132 of the extruder 80. When fibers are employed as the filler, they may be supplied to the hopper 42 at a relatively long length, such as a volume average length of from about 1,000 to about 5,000 micrometers, in some embodiments from about 2,000 to about 4,500 micrometers, and in some embodiments, from about 3,000 to about 4,000 micrometers. Nevertheless, by supplying these long fibers at a location where the liquid crystalline polymer is still in a solid state, the polymer can act as an abrasive agent for reducing the size of the fibers to a volume average length and length distribution as indicated above.

If desired, the ratio of the length (“L”) to diameter (“D”) of the screw may be selected to achieve an optimum balance between throughput and fiber length reduction. The L/D value may, for instance, range from about 15 to about 50, in some embodiments from about 20 to about 45, and in some embodiments from about 25 to about 40. The length of the screw may, for instance, range from about 0.1 to about 5 meters, in some embodiments from about 0.4 to about 4 meters, and in some embodiments, from about 0.5 to about 2 meters. The diameter of the screw may likewise be from about 5 to about 150 millimeters, in some embodiments from about 10 to about 120 millimeters, and in some embodiments, from about 20 to about 80 millimeters. The L/D ratio of the screw after the point at which the filler is supplied may also be controlled within a certain range. For example, the screw has a blending length (“L_{B}”) that is defined from the point at which the filler is supplied to the extruder to the end of the screw, the blending length being less than the total length of the screw. As noted above, it may be desirable to add the filler before the liquid crystalline polymer is melted, which means that the L_{B}/D ratio would be relatively high. However, too high of a L_{B}/D ratio could result in degradation of the polymer. Therefore, the L_{B}/D ratio of the screw after the point at which the filler is supplied is typically from about 4 to about 20, in some embodiments from about 5 to about 15, and in some embodiments, from about 6 to about 10.

In addition to the length and diameter, other aspects of the extruder may also be selected to help achieve the desired fiber length. For example, the speed of the screw may be selected to achieve the desired residence time, shear rate, melt processing temperature, etc. Generally, an increase in frictional energy results from the shear exerted by the turning screw on the materials within the extruder and results in the fracturing of the fibers, if employed. The degree of fracturing may depend, at least in part, on the screw speed. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

### VI. Molded Parts

Once formed, the polymer composition may be molded into any of a variety of different shaped parts using techniques as is known in the art. For example, the shaped parts may be molded using a one-component injection molding process in which dried and preheated plastic granules are injected into the mold. Regardless of the molding technique employed, it has been discovered that the polymer composition of the present invention, which possesses the unique combination of high flowability and good mechanical properties, is particularly well suited for parts having a small dimensional tolerance. Such parts, for example, generally contain at least one micro-sized dimension (e.g., thickness, width, height, etc.), such as from about 500 micrometers or less, in some embodiments from about 50 to about 450 micrometers, and in some embodiments, from about 100 to about 400 micrometers.

One such part is a fine pitch electrical connector. More particularly, such electrical connectors are often employed to detachably mount a central processing unit (“CPU”) to a printed circuit board. The connector may contain insertion passageways that are configured to receive contact pins. These passageways are defined by opposing walls, which may be formed from a thermoplastic resin. To help accomplish the desired electrical performance, the pitch of these pins is generally small to accommodate a large number of contact pins required within a given space. This, in turn, requires that the pitch of the pin insertion passageways and the width of opposing walls that partition those passageways are also small. For example, the walls may have a width of from about 500 micrometers or less, in some embodiments from about 50 to about 450 micrometers, and in some embodiments, from about 100 to about 400 micrometers. In the past, it has often been difficult to adequately fill a mold of such a thin width with a thermoplastic resin. Due to its unique properties, however, the polymer composition of the present invention is particularly well suited to form the walls of a fine pitch connector.

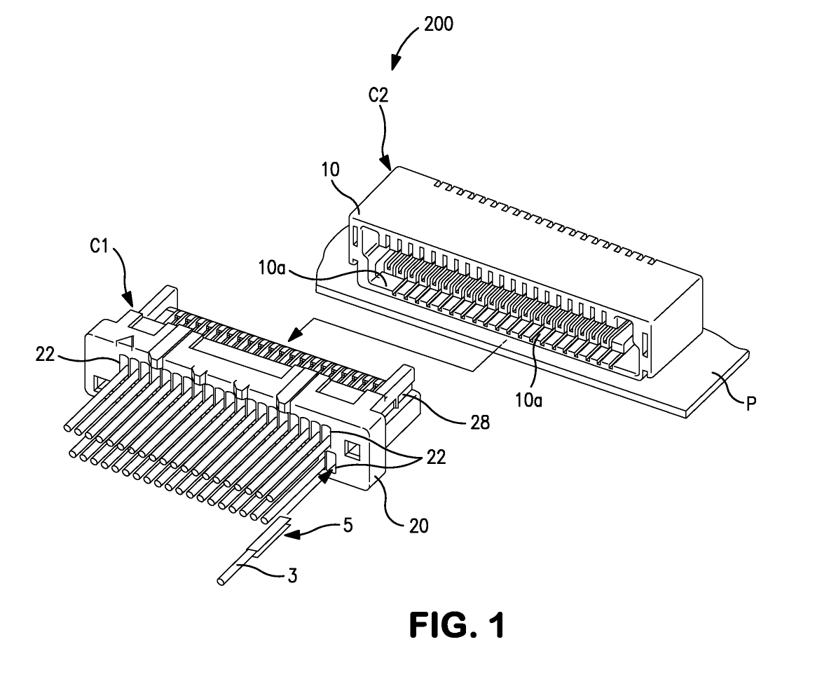

One example of a fine pitch electrical connector is shown in FIG. 1. An electrical connector 200 is shown that a board-side portion C2 that can be mounted onto the surface of a circuit board P. The connector 200 may also include a wiring material-side portion C1 structured to connect discrete wires 3 to the circuit board P by being coupled to the board-side connector C2. The board-side portion C2 may include a first housing 10 that has a fitting recess 10a into which the wiring material-side connector C1 is fitted and a configuration that is slim and long in the widthwise direction of the housing 10. The wiring material-side portion C1 may likewise include a second housing 20 that is slim and long in the widthwise direction of the housing 20. In the second housing 20, a plurality of terminal-receiving cavities 22 may be provided in parallel in the widthwise direction so as to create a two-tier array including upper and lower terminal-receiving cavities 22. A terminal 5, which is mounted to the distal end of a discrete wire 3, may be received within each of the terminal-receiving cavities 22. If desired, locking portions 28 (engaging portions) may also be provided on the housing 20 that correspond to a connection member (not shown) on the board-side connector C2.

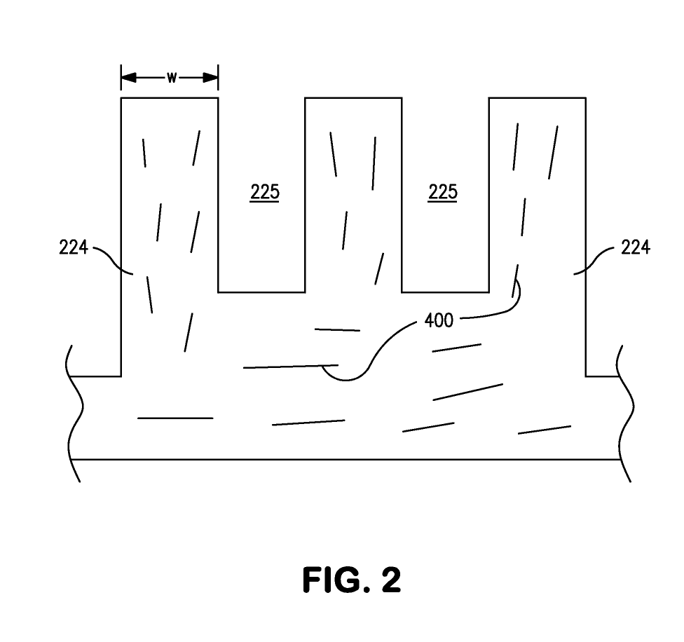

As discussed above, the interior walls of the first housing 10 and/or second housing 20 may have a relatively small width dimension, and can be formed from the polymer composition of the present invention. The walls are, for example, shown in more detail in FIG. 2. As illustrated, insertion passageways or spaces 225 are defined between opposing walls 224 that can accommodate contact pins. The walls 224 have a width “w” that is within the ranges noted above. When the walls 224 are formed from a polymer composition containing fibers (e.g., element 400), such fibers may have a volume average length and narrow length distribution within a certain range to best match the width of the walls. For example, the ratio of the width of at least one of the walls to the volume average length of the fibers is from about 0.8 to about 3.2, in some embodiments from about 1.0 to about 3.0, and in some embodiments, from about 1.2 to about 2.9.

In addition to or in lieu of the walls, it should also be understood that any other portion of the housing may also be formed from the polymer composition of the present invention. For example, the connector may also include a shield that encloses the housing. Some or all of the shield may be formed from the polymer composition of the present invention. For example, the housing and the shield can each be a one-piece structure unitarily molded from the polymer composition. Likewise, the shield can be a two-piece structure that includes a first shell and a second shell, each of which may be formed from the polymer composition of the present invention.

Of course, the polymer composition may also be used in a wide variety of other components having a small dimensional tolerance. For example, the polymer composition may be molded into a planar substrate for use in an electronic component. The substrate may be thin, such as having a thickness of about 500 micrometers or less, in some embodiments from about 50 to about 450 micrometers, and in some embodiments, from about 100 to about 400 micrometers. Examples of electronic components that may employ such a substrate include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, integrated circuits (e.g., SIM cards), etc.

In one embodiment, for example, the planar substrate may be applied with one or more conductive elements using a variety of known techniques (e.g., laser direct structuring, electroplating, etc.). The conductive elements may serve a variety of different purposes. In one embodiment, for example, the conductive elements form an integrated circuit, such as those used in SIM cards. In another embodiment, the conductive elements form antennas of a variety of different types, such as antennae with resonating elements that are formed from patch antenna structures, inverted-F antenna structures, closed and open slot antenna structures, loop antenna structures, monopoles, dipoles, planar inverted-F antenna structures, hybrids of these designs, etc. The resulting antenna structures may be incorporated into the housing of a relatively compact portable electronic component, such as described above, in which the available interior space is relatively small.

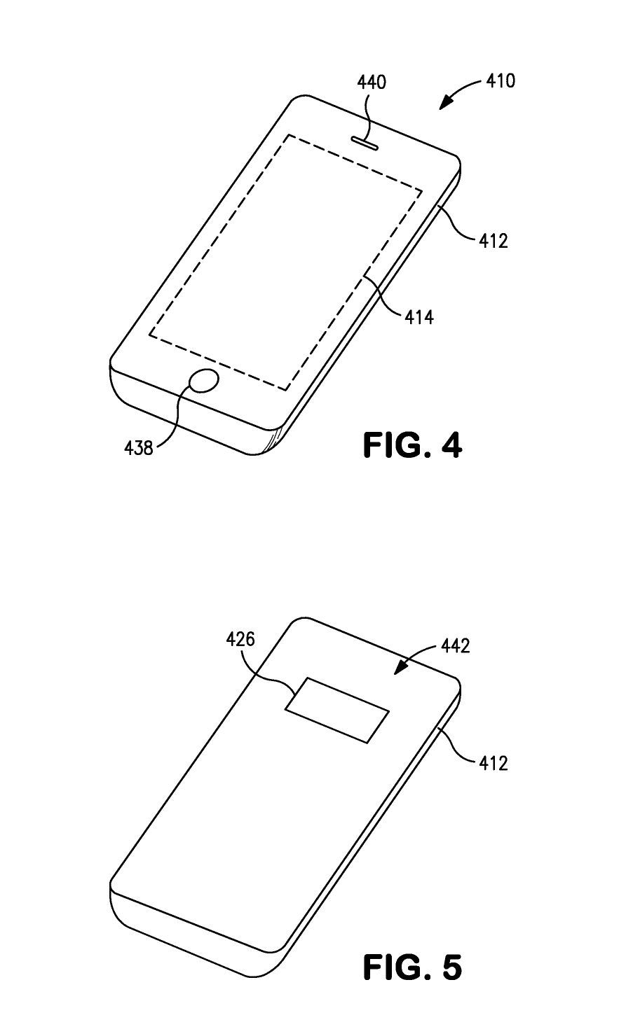

One particularly suitable electronic component that includes an antenna structure is shown in FIGS. 4-5 is a handheld device 410 with cellular telephone capabilities. As shown in FIG. 4, the device 410 may have a housing 412 formed from plastic, metal, other suitable dielectric materials, other suitable conductive materials, or combinations of such materials. A display 414 may be provided on a front surface of the device 410, such as a touch screen display. The device 410 may also have a speaker port 440 and other input-output ports. One or more buttons 438 and other user input devices may be used to gather user input. As shown in FIG. 5, an antenna structure 426 is also provided on a rear surface 442 of device 410, although it should be understood that the antenna structure can generally be positioned at any desired location of the device. As indicated above, the antenna structure 426 may contain a planar substrate that is formed from the polymer composition of the present invention. The antenna structure may be electrically connected to other components within the electronic device using any of a variety of known techniques. For example, the housing 412 or a part of housing 412 may serve as a conductive ground plane for the antenna structure 426.

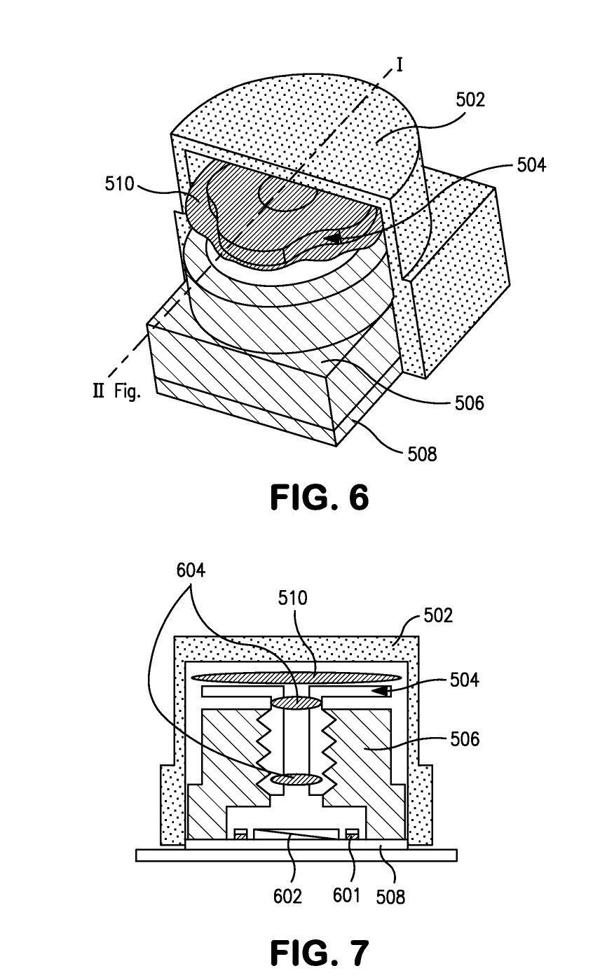

A planar substrate that is formed form the polymer composition of the present invention may also be employed in other applications. For example, in one embodiment, the planar substrate may be used to form a base of a compact camera module (“CCM”), which is commonly employed in wireless communication devices (e.g., cellular phone). Referring to FIGS. 6-7, for example, one particular embodiment of a compact camera module 500 is shown in more detail. As shown, the compact camera module 500 contains a lens assembly 504 that overlies a base 506. The base 506, in turn, overlies an optional main board 508. Due to their relatively thin nature, the base 506 and/or main board 508 are particularly suited to be formed from the polymer composition of the present invention as described above. The lens assembly 504 may have any of a variety of configurations as is known in the art, and may include fixed focus-type lenses and/or auto focus-type lenses. In one embodiment, for example, the lens assembly 504 is in the form of a hollow barrel that houses lenses 604, which are in communication with an image sensor 602 positioned on the main board 508 and controlled by a circuit 601. The barrel may have any of a variety of shapes, such as rectangular, cylindrical, etc. In certain embodiments, the barrel may also be formed from the polymer composition of the present invention and have a wall thickness within the ranges noted above. It should be understood that other parts of the camera module may also be formed from the polymer composition of the present invention. For example, as shown, a polymer film 510 (e.g., polyester film) and/or thermal insulating cap 502 may cover the lens assembly 504. In some embodiments, the film 510 and/or cap 502 may also be formed from the polymer composition of the present invention.

Printer parts may also contain the polymer composition of the present invention. Examples of such parts may include, for instance, printer cartridges, separation claws, heater holders, etc. For example, the composition may be used to form an ink jet printer or a component of an inkjet printer. In one particular embodiment, for instance, the ink cartridge may contain a rigid outer housing having a pair of spaced cover plates affixed to a peripheral wall section. In one embodiment, the cover plates and/or the wall section may be formed from the composition of the present invention.

The present invention may be better understood with reference to the following examples.

### Test Methods

UL94:

A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

| Vertical | |
|---|---|
| Ratings | Requirements |
| V-0 | Specimens must not burn with flaming combustion for more than 10 seconds |
| | after either test flame application. |
| | Total flaming combustion time must not exceed 50 seconds for each set of 5 |
| | specimens. |
| | Specimens must not burn with flaming or glowing combustion up to the |
| | specimen holding clamp. |
| | Specimens must not drip flaming particles that ignite the cotton. |
| | No specimen can have glowing combustion remain for longer than 30 seconds |
| | after removal of the test flame. |
| V-1 | Specimens must not burn with flaming combustion for more than 30 seconds |
| | after either test flame application. |
| | Total flaming combustion time must not exceed 250 seconds for each set of 5 |
| | specimens. |
| | Specimens must not burn with flaming or glowing combustion up to the |
| | specimen holding clamp. |
| | Specimens must not drip flaming particles that ignite the cotton. |
| | No specimen can have glowing combustion remain for longer than 60 seconds |
| | after removal of the test flame. |
| V-2 | Specimens must not burn with flaming combustion for more than 30 seconds |
| | after either test flame application. |
| | Total flaming combustion time must not exceed 250 seconds for each set of 5 |
| | specimens. |
| | Specimens must not burn with flaming or glowing combustion up to the |
| | specimen holding clamp. |
| | Specimens can drip flaming particles that ignite the cotton. |
| | No specimen can have glowing combustion remain for longer than 60 seconds |
| | after removal of the test flame. |

Melt Viscosity:

The melt viscosity (Pa-s) may be determined in accordance with ISO Test No. 11443 at a shear rate of 1000 s⁻¹ and temperature 15° C. above the melting temperature (e.g., 350° C.) using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Melting Temperature:

The melting temperature (“Tm”) was determined by differential scanning calorimetry (“DSC”) as is known in the art. The melting temperature is the differential scanning calorimetry (DSC) peak melt temperature as determined by ISO Test No. 11357. Under the DSC procedure, samples were heated and cooled at 20° C. per minute as stated in ISO Standard 10350 using DSC measurements conducted on a TA Q2000 Instrument.

Deflection Temperature Under Load (“DTUL”):

The deflection under load temperature was determined in accordance with ISO Test No. 75-2 (technically equivalent to ASTM D648-07). More particularly, a test strip sample having a length of 80 mm, thickness of 10 mm, and width of 4 mm was subjected to an edgewise three-point bending test in which the specified load (maximum outer fibers stress) was 1.8 Megapascals. The specimen was lowered into a silicone oil bath where the temperature is raised at 2° C. per minute until it deflects 0.25 mm (0.32 mm for ISO Test No. 75-2).

Tensile Modulus, Tensile Stress, and Tensile Elongation:

Tensile properties are tested according to ISO Test No. 527 (technically equivalent to ASTM D638). Modulus and strength measurements are made on the same test strip sample having a length of 80 mm, thickness of 10 mm, and width of 4 mm. The testing temperature is 23° C., and the testing speeds are 1 or 5 mm/min.

Flexural Modulus, Flexural Stress, and Flexural Strain:

Flexural properties are tested according to ISO Test No. 178 (technically equivalent to ASTM D790). This test is performed on a 64 mm support span. Tests are run on the center portions of uncut ISO 3167 multi-purpose bars. The testing temperature is 23° C. and the testing speed is 2 mm/min.

Notched Charpy Impact Strength:

Notched Charpy properties are tested according to ISO Test No. ISO 179-1) (technically equivalent to ASTM D256, Method B). This test is run using a Type A notch (0.25 mm base radius) and Type 1 specimen size (length of 80 mm, width of 10 mm, and thickness of 4 mm). Specimens are cut from the center of a multi-purpose bar using a single tooth milling machine. The testing temperature is 23° C.

Blister Free Temperature:

To test blister resistance, a 127×12.7×0.8 mm test bar is molded at 5° C. to 10° C. higher than the melting temperature of the polymer resin, as determined by DSC. Ten (10) bars are immersed in a silicone oil at a given temperature for 3 minutes, subsequently removed, cooled to ambient conditions, and then inspected for blisters (i.e., surface deformations) that may have formed. The test temperature of the silicone oil begins at 250° C. and is increased at 10° C. increments until a blister is observed on one or more of the test bars. The “blister free temperature” for a tested material is defined as the highest temperature at which all ten (10) bars tested exhibit no blisters. A higher blister free temperature suggests a higher degree of heat resistance.

Ten (10) bars are immersed in a silicone oil at a given temperature for 3 minutes, subsequently removed, cooled to ambient conditions, and then inspected for blisters (i.e., surface deformations) that may have formed. The test temperature of the silicone oil begins at 250° C. and is increased at 10° C. increments until a blister is observed on one or more of the test bars. The “blister free temperature” for a tested material is defined as the highest temperature at which all ten (10) bars tested exhibit no blisters. A higher blister free temperature suggests a higher degree of heat resistance.

### Example 1

A sample (Sample 1) is formed that contains 67.6 wt. % of a liquid crystalline polymer, 0.2 wt. % alumina trihydrate, 0.1 wt. % 4,4-biphenol, 10.0 wt. % glass fibers, 22.0 wt. % mica, and 0.1 wt. % of Hostanox® P-EPQ. A control sample is also formed that is identical to Sample 1, except that it lacks Hostanox® P-EPQ. To form the composition, pellets of the liquid crystalline polymer are dried at 150° C. overnight. Thereafter, the polymer is supplied to the feed throat of a ZSK-25 WLE co-rotating, fully intermeshing twin screw extruder in which the length of the screw is 750 millimeters, the diameter of the screw is 32 millimeters. The polymer is supplied to the feed throat by means of a volumetric feeder. The glass fibers, mica, and other additives are fed to Zones 4 and/or 6 of the extruder. Once melt blended, the samples are extruded through a dual-hole strand die, cooled through a water bath, and pelletized. The samples are then tested for mechanical and flammability properties. The results are set forth in Table 1 below.

TABLE 1

Sample

| | Control | 1 |
|---|---|---|
| Melt Viscosity, 1000 s⁻¹ (Pa · s) | 20 | 20 |
| Tensile Strength (MPa) | 136 | 137 |
| Elongation (%) | 1.8 | 1.9 |
| Notched Izod, kJ/m² | 4.4 | 4.9 |
| DTUL (° C.) | 274 | 272 |
| Blister Free Temp (° C.) | >280 | >280 |
| Flammability | 0.8 mm-V2 | 0.8 mm-V0 |
| | 3/10 | 1/10 |
| | | 0.25 mm-V0 |

As indicated, Sample 1 achieved a V0 rating without a substantial change in the melt viscosity or mechanical strength.

### Example 2

A sample (Sample 2) is formed that contains 69.9 wt. % of a liquid crystalline polymer, 30.0 wt. % talc, and 0.1 wt. % of Hostanox® P-EPQ. A control sample is also formed that is identical to Sample 2, except that it lacks Hostanox® P-EPQ. To form the composition, pellets of the liquid crystalline polymer are dried at 150° C. overnight. Thereafter, the polymer is supplied to the feed throat of a ZSK-25 WLE co-rotating, fully intermeshing twin screw extruder in which the length of the screw is 750 millimeters, the diameter of the screw is 32 millimeters. The polymer is supplied to the feed throat by means of a volumetric feeder. The glass fibers, mica, and other additives are fed to Zones 4 and/or 6 of the extruder. Once melt blended, the samples are extruded through a dual-hole strand die, cooled through a water bath, and pelletized. The samples are then tested for mechanical and flammability properties. The results are set forth in Table 2 below.

TABLE 2

Sample

| | Control | 2 |
|---|---|---|
| Melt Viscosity, 1000 s⁻¹ (Pa · s) | 53 | 51 |
| Tensile Strength (MPa) | 132 | 129 |
| Elongation (%) | 4.28 | 5.05 |
| Flexural Strength (MPa) | 141 | 139 |
| Notched Izod, kJ/m² | 15 | 10 |
| DTUL (° C.) | 259 | 260 |
| Blister Free Temp (° C.) | >280 | 270 |
| Flammability | V1 @ | V0 @ |
| | 0.8 mm | 0.8 mm |

### Example 3

Samples (Samples 3-4) are formed that contains 69.5 wt. % of a liquid crystalline polymer, 0.4 wt. % alumina trihydrate, 0.01 wt. %, 2,6-naphthalene dicarboxylic acid (“NDA”), 30.0 wt. % talc, and 0.05 to 0.1 wt. % of Hostanox® P-EPQ. A control sample is also formed that is identical to Samples 3-4, except that it lacks Hostanox® P-EPQ. To form the composition, pellets of the liquid crystalline polymer are dried at 150° C. overnight. Thereafter, the polymer is supplied to the feed throat of a ZSK-25 WLE co-rotating, fully intermeshing twin screw extruder in which the length of the screw is 750 millimeters, the diameter of the screw is 32 millimeters. The polymer is supplied to the feed throat by means of a volumetric feeder. The glass fibers, mica, and other additives are fed to Zones 4 and/or 6 of the extruder. Once melt blended, the samples are extruded through a dual-hole strand die, cooled through a water bath, and pelletized. The samples are then tested for mechanical and flammability properties. The results are set forth in Table 3 below.

TABLE 3

| | Sample | | |
|---|---|---|---|
| | Control | 3 | 4 |
| Tensile Strength (MPa) | 130 | 130 | 123 |
| Elongation (%) | 4.24 | 4.74 | 4.59 |
| Flexural Strength (MPa) | 137 | 136 | 136 |
| Notched Izod, kJ/m² | 12.5 | 14.7 | 16.0 |
| DTUL (° C.) | 260 | 259 | 255 |
| Blister Free Temp (° C.) | >280 | >280 | >280 |
| Flammability | V1 @ | V1 @ | V0 @ |
| | 0.25 mm | 0.25 mm | 0.25 mm |
| | (8 of 10 | (4 of 10 | (1 of 10 |
| | dripping) | dripping) | dripping) |

### Example 4

A sample (Sample 5) is formed that contains 59.69 wt. % of a liquid crystalline polymer, 0.2 wt. % alumina trihydrate, 0.01 wt. %, 2,6-naphthalene dicarboxylic acid (“NDA”), 40.0 wt. % glass fibers, and 0.1 wt. % of Hostanox® P-EPQ. A control sample is also formed that is identical to Sample 5, except that it lacks Hostanox® P-EPQ. To form the composition, pellets of the liquid crystalline polymer are dried at 150° C. overnight. Thereafter, the polymer is supplied to the feed throat of a ZSK-25 WLE co-rotating, fully intermeshing twin screw extruder in which the length of the screw is 750 millimeters, the diameter of the screw is 32 millimeters. The polymer is supplied to the feed throat by means of a volumetric feeder. The glass fibers, mica, and other additives are fed to Zones 4 and/or 6 of the extruder. Once melt blended, the samples are extruded through a dual-hole strand die, cooled through a water bath, and pelletized. The samples are then tested for mechanical and flammability properties. The results are set forth in Table 4 below.

TABLE 4

| | Sample | |
|---|---|---|
| | Control | 5 |
| Melt Viscosity, | 23 | 24 |
| 1000 s⁻¹ (Pa · s) | | |
| Tensile Strength (MPa) | 127 | 121 |
| Elongation (%) | 1.21 | 1.43 |
| Tensile Modulus (MPa) | 17400 | 16600 |
| Notched Izod (kJ/m²) | 7.4 | 9.0 |
| DTUL (° C.) | 290 | 286 |
| Flammability | V1 @ 0.8 mm | V0 @ 0.8 mm |
| | (2 of 10 drip, long flame time) | (0 of 10 drip) |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising a liquid crystalline polymer having a melt viscosity of about 50 Pa-s or less as determined in accordance with ISO Test No. 11443 at a shear rate of 1000 seconds⁻¹ and temperature that is 15° C. above the melting temperature of the polymer, wherein the polymer is melt blended with an inorganic filler in an amount of from about 0.1 to about 35 parts per 100 parts of the polymer and an organophosphorous compound in an amount of from about 0.01 to about 5 parts per 100 parts of the polymer.

2. The polymer composition of claim 1, wherein the polymer composition has a melt viscosity of about 80 Pa-s or less, as determined in accordance with ISO Test No. 11443 at a shear rate of 1000 seconds⁻¹ and temperature that is 15° C. above the melting temperature of the composition.

3. The polymer composition of claim 1, wherein the polymer has a total amount of repeating units derived from naphthenic hydroxcarboxylic and/or naphthenic dicarboxylic acids of more than 15 mol. %.

4. The polymer composition of claim 3, wherein the polymer contains monomer units derived from 2,6-naphthalenedicarboxylic acid.

5. The polymer composition of claim 3, wherein the polymer contains monomer units derived from 4-hydroxybenzoic acid, terephthalic acid, isophthalic acid, hydroquinone, 4,4′-biphenol, acetaminophen, or a combination thereof.

6. The polymer composition of claim 1, wherein the filler includes glass fibers, a mineral filler, or a combination thereof.

7. The polymer composition of claim 1, wherein the organophosphorous compound includes a phosphite, phosphonite, or a combination thereof.

8. The polymer composition of claim 7, wherein the compound includes an aryl phosphonite that contains C₁ to C₁₀ alkyl substituents.

9. The polymer composition of claim 8, wherein the aryl phosphonite has the following general formula (I): 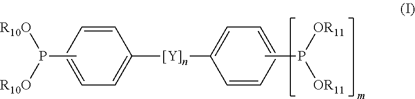
wherein,
m is 0 or 1;
n is 0 or 1;
R₁₀ and R₁₁ are independently an aliphatic, alicyclic or aromatic group of 1 to 24 carbon atoms, optionally further substituted, or both groups R₁₀ and/or R₁₁ form a cyclic group with a single phosphorus atom;
Y is —O—, —S—, —CH(R₁₅)— or —C₆H₄—, where R₁₅ is hydrogen, C₁₋₆ alkyl, or COOR₆ and R₆ is C₁₋₁₈ alkyl.

10. The polymer composition of claim 8, wherein the aryl phosphonite has the following general formula (x): 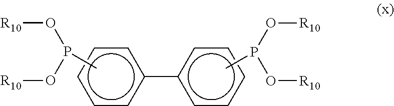
wherein R₁₀ and R₁₁ are independently a linear, branched or cyclic C₁₋₂₄ aliphatic groups or aromatic groups, optionally substituted with from 1 to 4 C₁₋₁₂ alkyl or aryl groups.

11. The polymer composition of claim 10, wherein R₁₀ and/or R₁₁ are 2,4-di-tert-butylphenyl.

12. The polymer composition of claim 1, wherein the composition further comprises a mineral filler.

13. The polymer composition of claim 1, wherein the composition is generally free of polytetrafluoroethylene.

14. A molded part comprising the polymer composition of claim 1.

15. The molded part of claim 14, wherein the part exhibits a total flame time of about 50 seconds or less, as determined in accordance with UL94 at a thickness of 0.8 mm after conditioning for 48 hours at 23° C. and 50% relative humidity.

16. The molded part of claim 14, wherein the part exhibits a total number of drips of 3 or less, as determined in accordance with UL94 at a thickness of 0.8 mm after conditioning for 48 hours at 23° C. and 50% relative humidity.

17. The molded part of claim 14, wherein the part exhibits a V0 rating as determined in accordance with UL94 after conditioning for 48 hours at 23° C. and 50% relative humidity.

18. The molded part of claim 14, wherein the part exhibits a blister free temperature of about 240° C. or greater.

19. The molded part of claim 14, wherein the part has at least one dimension of about 500 micrometers or less.

20. An electrical connector that comprises opposing walls between which a passageway is defined for receiving a contact pin, wherein at least one of the walls contains the molded part of claim 14.

21. A camera module that comprises the molded part of claim 14.
